(19) United States
(12) Patent Application Publication
(10) Pub. No.: US 2013/0215026 A1
(43) Pub. Date: Aug. 22, 2013

(54) INPUT DEVICE, INPUT METHOD AND ASSEMBLY

(71) Applicants: Kenji Shinozaki, Tokyo (JP); Masahiro Suzuki, Tokyo (JP)

(72) Inventors: Kenji Shinozaki, Tokyo (JP); Masahiro Suzuki, Tokyo (JP)

(73) Assignee: SHOWA DENKO K.K., Minato-ku, Tokyo (JP)

(21) Appl. No.: 13/882,894

(22) PCT Filed: Sep. 5, 2011
(86) PCT No.: PCT/JP2011/070157

§ 371 Date: May 1, 2013

(30) Foreign Application Priority Data
Nov. 2, 2010 (JP) 2010-246418

(51) Int. Cl. G06F 3/044

(52) U.S. Cl. CPC G06F 3/044
USPC 345/157

(57) ABSTRACT

Disclosed is an input device for a capacitive touch panel, which is an input device for inputting the position on the touch panel by making the input device contact with the touch panel, including an insulating layer (11) having flexibility, and a conductive layer (12) laminated onto the insulating layer (11), and the plural units that are configured by the insulating layer (11) and the conductive layer (12) are laminated to be a laminated body, and the input device (10) forms a cylindrical shape. Thereby, users less likely to have a sense of wear and tear of fingers, the accuracy of the position detected by the touch panel is improved, input means is less likely to be lost though the input device is lost, and it is less likely to produce distortions and the like on the surface of the touch panel.

### TECHNICAL FIELD

The present invention relates to an input device or the like used for, for example, a capacitive touch panel.

### BACKGROUND ART

In recent years, touch panels which enable information to be inputted by touching a display screen of a display device have increased in importance. A sensor which detects the contact is applied to the display screen of the touch panel, and the sensor detects the position of the contact with a finger or the like on the display screen, thereby information is inputted. So-called capacitive touch panels, in which a sensor adopting a method of detecting the position by capturing the change of the capacitance between a finger or the like and a conducting layer is used as the sensor, have been becoming popular.

Patent Document 1 discloses a touch pen in which a grip part is formed to be a bar whose cross-sectional shape is substantially circular, concave grooves (holding portions) having dents are symmetrically formed on each side, and an orientation to the periphery direction is provided.

Patent Document 2 discloses a touch pen for inputting information into a device by coming into contact with a touch panel of a computer, that includes a jig tool wearable on a finger and a pen point attached to the jig tool.

### CITATION LIST

### Patent Literature

Patent Document 1: Japanese Patent Application Laid-Open Publication No. 2009-230179

Patent Document 2: Japanese Patent Application Laid-Open Publication No. 2009-259062

### DISCLOSURE OF INVENTION

### Technical Problem

In the case of using a finger to input into the touch panel, for example, a touch panel screen gets contaminated with skin oil and unclear, or the users have a sense of wear and tear of finger by a long period of use, because the touch panel directly contacts with a finger. Further, in the case of using a finger, it is difficult to reduce a contact area between the finger and the touch panel, and it tends to decrease the accuracy of detecting the position by the touch panel.

On the other hand, for example, an input device of pen type such as a stylus pen and the like tends to be lost, and if lost, a means for inputting into the touch panel is lost in some cases. Further, a stylus pen and the like are likely to damage the surface of the touch panel if writing pressure is high and dust is caught up, in general.

In light of the above-described problem, an object of the present invention is to provide an input device and the like for the capacitive touch panel, with which the users are less likely to have a sense of wear and tear of finger, and, which improves the accuracy of detecting the position by the touch panel, also, is less likely to lose input means though the input device is lost, further, is less likely to damage the surface of the touch panel.

### Solution to Problem

An input device according to the present invention for inputting a position on a capacitive touch panel by making the input device contact with the touch panel includes: an insulating layer that has flexibility, and a conductive layer that is laminated onto the insulating layer, wherein plural units are laminated to be a laminated body and form a cylindrical shape, the unit is configured by the insulating layer and the conductive layer.

Here, it is preferable that an adhesive layer that is provided at least on a part of the unit is included. Further, the laminated body can be the units that are folded and overlapped. Moreover, it is preferable that the thickness of the laminated body is in the range of 10 μm to 300 μm. Further, the laminated body can be the units that are winded several times.

An input device according to the present invention for inputting a position on a capacitive touch panel by making the input device contact with the touch panel includes: an insulating layer that has flexibility, and a conductive layer that is laminated onto the insulating layer, wherein plural units are laminated to be a laminated body, and the laminated body can be bended to fit a shape of a supporting body, the unit is configured by the insulating layer and the conductive layer.

Here, it is preferable that an adhesive layer provided at least on a part of the unit is included. Further, the supporting body can be a finger. Moreover, it is preferable that the laminated body integrally forms a shape of pentagon or hexagon.

An input method according to the present invention includes: making the above-described input device contact with the touch panel to input a position on a capacitive touch panel.

An assembly according to the present invention is the assembly in which input devices for inputting a position on a capacitive touch panel by making the input device contact with the touch panel are gathered, wherein: the input devices include a laminated body in which plural units are laminated, the unit is configured by an insulating layer that has a flexibility and a conductive layer that is laminated onto the insulating layer; and the input devices are gathered by any one of (1) to (3) below, (1) further including an adhesive layer provided at least on a part of the unit and making the input devices laminated with the adhesive layer interposed therebetween, (2) planately combining the input devices with each other, and (3) forming the input device to be cylindrical shape and making the input devices of cylindrical shape laminated.

### Advantageous Effects of Invention

According to the present invention, it is possible to provide an input device and the like for the capacitive touch panel, with which the users are less likely to have a sense of wear and tear of finger, and, which improves the accuracy of detecting the position by the touch panel, also, is less likely to lose input means though the input device is lost, further, is less likely to damage the surface of the touch panel.

### BRIEF DESCRIPTION OF DRAWINGS

FIGS. 1A and 1B are diagrams for illustrating one specific example of the input device to which the exemplary embodiment is applied;

FIGS. 2A to 2C are the first to third specific examples of usage manner of the input device;

FIGS. 3A to 3C are diagrams for illustrating other example of the input device to which the exemplary embodiment is applied;

FIGS. 4A to 4C are diagrams for illustrating other example of the input device to which the exemplary embodiment is applied; and

FIGS. 5A to 5C are diagrams for illustrating the first to third specific examples of the assembly of the input devices.

### DESCRIPTION OF EMBODIMENTS

### Description of Input Device

Hereinafter, an exemplary embodiment according to the present invention will be described in detail with reference to the attached drawings.

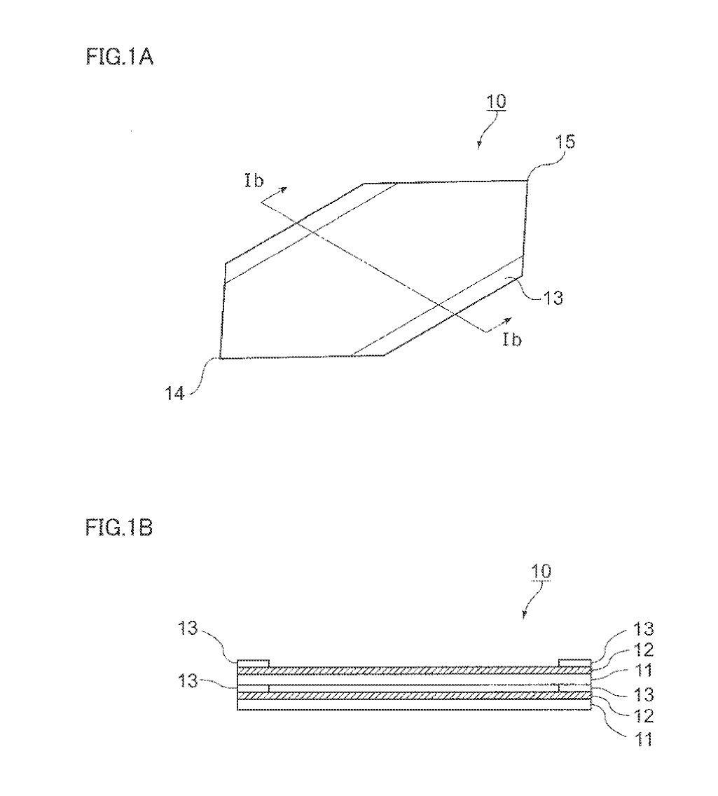

FIGS. 1A and 1B are diagrams for illustrating a specific example of input device to which the exemplary embodiment is applied.

An input device 10 is an input device for inputting a position on a touch panel by contact with a capacitive (capacitive-type, capacitive coupling type) touch panel. FIG. 1A is a perspective view for illustrating the entire input device 10, and FIG. 1B is a Ib-Ib cross-sectional view in FIG. 1A.

As shown in FIGS. 1A and 1B, the input device 10 includes an insulating layer 11 having flexibility, a conductive layer 12 formed to be laminated onto the insulating layer 11, and an adhesive layer 13 provided onto a part of the conductive layer 12. The insulating layer 11, the conductive layer 12, and the adhesive layer 13 are formed by two layers, respectively. Here, in the case of assuming the insulating layer 11 and the conductive layer 12 as a single unit, two units are included in the input device 10, and the two units form a laminated body with the adhesive layer 13 interposed therebetween. The insulating layer 11 and the conductive layer 12 integrally form a planate hexagon.

The insulating layer 11 is a base material for forming the conductive layer 12, and has insulating property. Also the insulating layer 11 has flexibility and can be bended. Thereby, it is possible to be fitted to the shape of a supporting body for wearing the input device 10. Here, the supporting body is a finger or a writing material, although detailed description thereof will be given later. The shape of the input device 10 can be fitted to the shape of the supporting body, for example, by winding the input device 10 around a finger or a writing material.

As the material of the insulating layer 11 which satisfies such requirements, for example, a resin sheet can be used. More specifically, the resin sheet made with polypropylene (PP), polyester, nylon, polyvinyl chloride (PVC), polycarbonate (PC), polyethylene terephthalate (PET), or the like can be used. The thickness of such resin sheet may be in the range of 10 μm to 300 μm, for example.

The conductive layer 12 has the conductive property and is provided for flowing current between the touch panel and the human body. Thereby, the input device 10 functions as an input device for capacitive touch panel. In the exemplary embodiment, the conductive layer 12 includes, metal, conductive oxide, conductive polymer, and the like, therefore the conductive layer 12 has the conductive property. Here, as metals, aluminium (Al), silver (Ag), titanium (Ti), and gold (Au) and the like are included. As the conductive oxide, indium oxide, tin oxide, titanium oxide, zinc oxide and the like are included. More specifically, indium tin oxide, indium zinc oxide, titanium oxide, niobium oxide, and the like are included. Further, as the conductive polymer, including dopant, polythiophene, polypyrrole, polyaniline, derivative of those and the like are included. Of these, the conductive layer 12 is preferably composed of aluminium (Al), in terms of ease of evaporating and the like and low cost of production as described later.

If the thickness of the conductive layer 12 is too thin, the conductive property can not be ensured, however, if the thickness is too thick, plastic deformation tends to be caused due to the bend which occurs when adjusting the shape of the input device 10 with that of the supporting body. Practically, when the input device 10 is used, the bend causes wrinkles. If the bend occurs in a leading portion 14 where the input device 10 contacts with the touch panel, the contact between the input device 10 and the touch panel is likely to be a point contact. It is less likely to cause a contact failure when the contact between the input device 10 and the touch panel is a surface contact. Therefore, in terms of ensuring the conductive property and making less likely to cause a contact failure, the conductive layer 12 of the exemplary embodiment is preferably formed by the metal thin film. The thickness can be, for example, preferably in the range of 10 nm to 100 μm. It should be noted that the conductive layer 12 may be provided on only a part of the insulating layer 11, as long as the conductive property is ensured.

Such conductive layer 12 can be formed by coating the top of the insulating layer 11 with evaporation coating and the like. In this case, the insulating layer 11 and the conductive layer 12 can be regarded as a metal laminate film.

The adhesive layer 13 is provided so as to keep the shape of the input device 10 when the input device 10 is fitted to the shape of the supporting body, or to fix the supporting body and the input device 10 when the input device 10 is bonded to the supporting body.

In order to exert such a feature, the adhesive layer 13 is preferably composed of pressure sensitive adhesives. In other words, it is preferable that the adhesion is completed at the moment adhesive parts are set together. Further, in the case where the supporting body is bonded to the input device 10 to be fixed, the adhesion between the supporting body and the input device 10 is not necessarily strong, and it is more preferable that the input device 10 can be separated from the supporting body with ease. In the exemplary embodiment, as an uppermost layer, the adhesive layers 13 are provided on two portions, that is, a portion along with one of the lines of the hexagon shape of the input device 10 and a portion along with a line opposite to the line.

Further, in the exemplary embodiment, the adhesive layer 13 is used for forming the laminated body by bonding the units configured by the insulating layer 11 and the conductive layer 12 each other. Note that, the adhesive layer 13 provided between the units is preferably provided in the minimum area as long as the laminated body is maintained. Thereby, the input device 10 can be fitted to the shape of the supporting body without distortions due to sliding of the units with each other. Therefore, it is more preferable that the adhesive layer 13 is partially provided than entirely provided on the surface between the units to connect the units. Specifically, the input device 10 of the exemplary embodiment is easy to bend at a portion to be contacted with the touch panel (a contacting surface), therefore distortions tend to occur in particular. It is preferable to provide the adhesive layer 13 not on the part to be the contacting surface but on other portion. In the input device 10 of the exemplary embodiment, as shown in FIG. 1B, the adhesive layer 13 between the units is provided at the same position as the adhesive layer 13 provided as the uppermost layer. Moreover, although the details are described later, the adhesive layer 13 between the units is not provided in the vicinity of the leading portion 14, since the vicinity of the leading portion 14 is to be the contacting surface.

In the exemplary embodiment, plural units, each of which is configured by the insulating layer 11 and the conductive layer 12, are laminated to be a laminated body. Thereby, it is easier to satisfy both conductive property and flexibility. That is, the flexibility of the materials used for the conductive layer 12 of the input device 10 is generally inferior as compared with that of the materials like resin and the like used for the insulating layer 11. It is particularly remarkable in the case where metal oxide is chosen as the material used for the conductive layer 12. Even if such material is used, the conductive layer 12 can have flexibility when the thickness thereof is thin enough. However, if the thickness of the conductive layer 12 is too thin, the conductive property decreases as described above, and it is likely not to function as the input device 10 used for the capacitive touch panel. On the other hand, if the thickness is too thick, the flexibility is lost and plastic deformation tends to occur due to the bend as described above. To avoid this, metal is preferably used as the material used for the conductive layer 12, however, in this case, design property of the input device 10 might be limited.

In the input device 10 of the exemplary embodiment, a structure is adopted in which the conductive layer 12 is divided into more than one and the insulating layer 11 is sandwiched between the conductive layers 12. By adopting the structure, plural conductive layers 12 whose thickness are thin can be provided with the insulating layer 11 interposed therebetween. So the flexibility can be ensured by adopting the thin conductive layer 12, and the conductive property can be ensured by providing the plural conductive layers 12. The thickness of the laminated body is, for example, in the range of 10 μm to 300 μm.

It should be noted that, in the specific example as shown in the FIGS. 1A and 1B, the two units which are configured by the insulating layer 11 and the conductive layer 12 are laminated to be the laminated body, but it is not limited thereto, and three or more units may be laminated. Moreover, in the specific example as described above, the laminated body configures the whole of the input device 10, but it is not limited thereto, and the laminated body may partially configure the input device 10. For instance, the portion of the input device 10 which contacts with the touch panel (a contacting surface) may be such a laminated body.

By using the input device 10, it is not necessary for the users to directly touch the touch panel with fingers to handle the touch panel, and the users are less likely to have a sense of wear and tear of finger. Further, it is possible to reduce the contact area with the touch panel compared to the case of using a finger. Therefore, the accuracy of detecting the position of the part to contact with the touch panel can be improved.

In the exemplary embodiment, the input device 10 is configured with a double structure of the insulating layer 11 and conductive layer 12. If only the insulating layer 11 is provided, it is difficult to flow faint electric current between the touch panel and a human body, and the input device does not work. Also, if only the conductive layer 12 is provided, in the case where the conductive layer 12 is formed with metals, as described above, it is likely to be a point contact on the leading portion 14 and to cause a contact failure. On the other hand, in the input device 10 of the exemplary embodiment, in which the insulating layer 11 is composed of a resin sheet and the like having flexibility, the leading portion 14 is elastically deformed and bended to contact with the touch panel. Therefore, it is likely to be the surface contact and it becomes easier to flow faint electric current.

Moreover, compared to the conventional stylus pen and the like having flexibility, the input device 10 of the exemplary embodiment makes it less likely to cause damage and the like on the surface of the touch panel and less likely to damage the touch panel.

Further, many of the touch panels in recent years can detect plural contacting points. That is, so-called multi-touch is available, and by using the multi-touch to perform a predetermined operation to the touch panel, for instance, various sorts of functions including reduction and enlargement of images and the like are realized. However, in the case of using a stylus pen and the like as the input device, it is difficult to touch plural points on the touch panel at the same time. On the other hand, with the input device 10 of the exemplary embodiment, by wearing the input devices 10 on plural fingers, it is easy to touch plural points on the touch panel at the same time.

Further, by using the input device 10 of the exemplary embodiment, a so-called disposable input device is realized.

For instance, it is easy to carry an assembly of the input devices 10, described further below, which can be used by taking as much the input devices 10 as need to be worn on the pen or on the finger whenever the users need. The used input devices 10 may be discarded.

Alternatively, the need for the users of carrying around with the input device 10 decreases by putting the input device 10 at a place to use beforehand. Further, it is much easier to provide the alternate input device 10 than a stylus pen and the like in the case of being lost.

Further, in the case of using a resin sheet as the insulating layer 11 for the input device 10 of the exemplary embodiment, it is possible to print on it. In other words, it is easy to make an excellent design because a name or the usage of the input device 10, or a various sorts of patterns can be printed.

It is more preferable to provide the adhesive layer 13 in the point that the users can freely set the shape of the cylindrical input device 10 to fit the shape of the individual supporting body. Note that, the input device 10 may be distributed in a state of cylindrical shape beforehand. In this case, it is considered not to provide the adhesive layer 13 but to bond by pressure, welding and the like for maintaining the cylindrical shape. In this case, the adhesive layer 13 is not always necessary.

### Description of Usage Manner of the Input Device

Specific usage manners of the above-described input device 10 will be described.

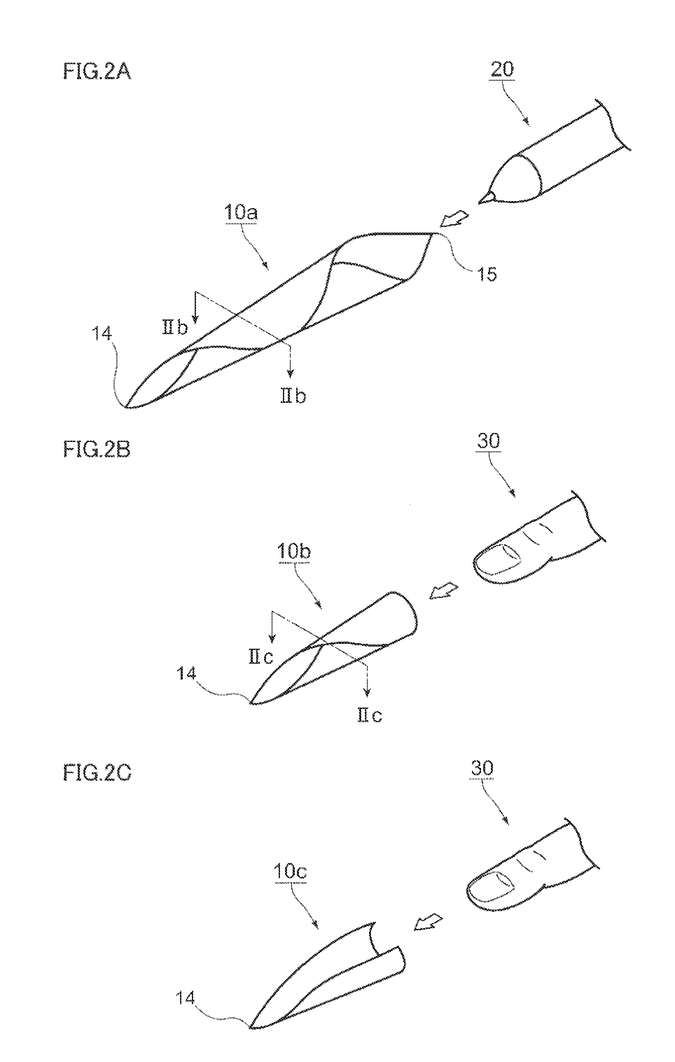

FIGS. 2A to 2C are diagrams for illustrating the first to third specific examples of usage manner of the input device 10.

Here, FIG. 2A is a diagram for illustrating the first example of usage manner of the input device 10.

FIG. 2A shows the case where the input device 10 shown in FIG. 1 forms a cylindrical shape by winding to fit the shape of a writing material 20. It should be noted that, here, the input device 10 of the cylindrical embodiment is referred to as an input device 10a for the sake of discrimination. This input device 10a is winded as the insulating layer 11 outside and as the conductive layer 12 inside, and is bonded and fitted by the adhesive layer 13 provided on the edge of the input device 10, so that this input device 10a can keep a cylindrical shape. The input device 10a is used in a state of being worn on the writing material 20 inserted from the side of a leading portion 15 at the position opposite to the leading portion 14 as well.

In the exemplary embodiment, the input device 10 forms a tapering shape from the leading portion 15 to the leading portion 14 to form a cylindrical shape. Thereby, when the input device 20 is inserted from the leading portion 15, the insertion can be easily performed, but the writing material 20 can not penetrate toward the direction of the leading portion 14. Thus, it is possible for the input device 10a to be worn steadily on the writing material 20. Also at this time, with the adhesive layer 13 provided on the entire surface of the conductive layer 12, this adhesive layer 13 and the writing material 20 are bonded and fitted, thereby it is possible to stabilize them moreover.

Note that, it is possible to use the input device 10a provided as the cylindrical embodiment, by wearing the input device 10 on the writing material 20 to wind. At this time, a mark for deciding the position (for instance, a mark for fitting the leading position of the writing material 20) is preferably pictured on the input device 10 when the input device 10 is worn.

The users of the touch panel can input information into the touch panel by gripping the input device 10a worn on the writing material 20 to make the leading portion 14 of the input device 10a contact with the touch panel. At this time, at least a part of the input device 10a is preferably contacted with a hand gripping the writing material 20.

In this case, the writing material 20 can be an ordinal writing material like a pen and the like. So, in the case of this embodiment, the users can input information into the touch panel by using their favorite or familiar writing material. In this case, a device available for both inputting into the touch panel and writing in an ordinal way can be provided.

FIG. 2B is a diagram for illustrating the second example of usage manner of the input device 10.

FIG. 2B shows the diagram, in which the input device 10 shown in FIG. 2A is cut at the IIb-IIb in FIG. 2A. Here, this input device 10 is referred to as an input device 10b for the sake of discrimination. The input device 10b is used in the state of being inserted from the side of the cutting surface to be worn on the finger 30. In the exemplary embodiment, the input device 10b forms a tapering shape from the cutting surface to the leading portion 14 as described above. Therefore, the finger 30 can not penetrate toward the leading portion 14. Thereby, the input device 10b can be worn on the writing material 20 steadily. Further, with the adhesive layer 13 provided on the entire surface of the conductive layer 12, this adhesive layer 13 and the finger 30 are bonded and fitted, thereby it is possible to stabilize them moreover.

The users of the touch panel can input information into the touch panel by making the leading portion 14 of the input device 10b worn on the finger 30 contact with the touch panel.

FIG. 2C is a diagram for illustrating the third example of the usage manner of the input device 10.

FIG. 2C shows a diagram, in which the input device 10b in FIG. 2B is cut at the IIc-IIc in FIG. 2B additionally. Here, this input device 10 is referred to as an input device 10c for the sake of discrimination. The input device 10c, which does not have enough width to wind around the entire finger 30, is used in a state of being worn while contacting with a part of the finger 30. In this case, the input device 10c and the finger 30 are bonded and fitted by the adhesive layer 13.

The users of the touch panel can input information into the touch panel by making the leading portion 14 of the input device 10c worn on the finger 30 contact with the touch panel.

Therefore, the input device 10 of the exemplary embodiment can be fitted to the shape of the supporting body with ease, because the insulating layer 11 and the conductive layer 12 can be bended integrally. In order to further facilitate inputting into the touch panel, it is easy to adjust the length by cutting or the like as in the cases of the above-described inputting devices 10b and 10c. In the case where the input devices 10b and 10c are rolled out, for example, they have the shape of being cut at the Ib-Ib in FIG. 1A, and in this case, they form a shape of pentagon.

Note that, in this exemplary embodiment, the conductive layer 12 is winded as inside, so the insulating layer 11 is outside. Thereby it is the insulating layer 11 to contact with the touch panel directly. However, also in this case, from the capacitive touch panel, it is possible to flow faint electric current through the input devices 10a, 10b, and 10c, and a human body. Thus, there is no problem of inputting information into the touch panel by the input devices 10a, 10b, and 10c.

The input devices 10a, 10b, and 10c are provided by winding the input device 10 shown in the FIGS. 1A and 1B as the insulating layer 11 outside and as the conductive layer 12 inside, however, it can be provided by winding as the insulating 11 inside and as the conductive layer 12 outside.

It should be noted that, the means for inputting information into the touch panel by using such above-described input devices 10a, 10b, and 10c, can be considered as an input method featured of inputting the position on the touch panel by making the input devices 10a, 10b, and 10c contact with the capacitive-type touch panel.

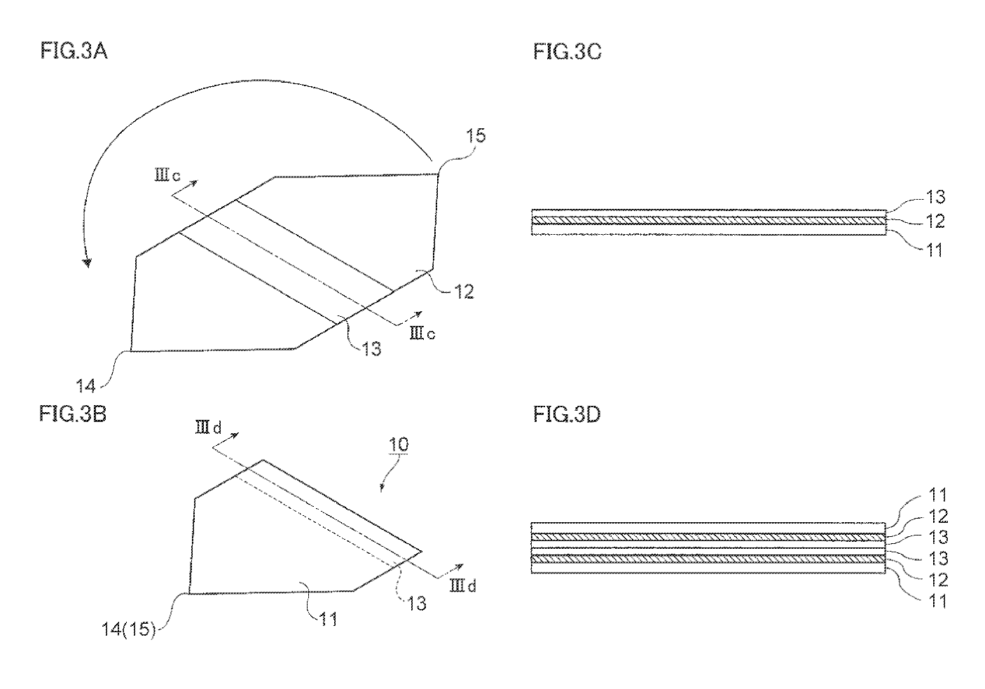

FIGS. 3A to 3C are diagrams for illustrating other example of the input device 10 to which the exemplary embodiment is applied.

Here, the input device 10 shown in FIG. 3B is the sheet shown in FIG. 3A folded in half. FIG. 3C is a IIIc-IIIc cross-sectional view of the sheet shown in FIG. 3A. Further, FIG. 3D is a IIId-IIId cross-sectional view of the input device 10 shown in FIG. 3B.

As shown in FIG. 3C, the sheet in FIG. 3A is configured by the structure in which the insulating layer 11, conductive layer 12, and the adhesive layer 13 are laminated. By folding the sheet in FIG. 3A in half so that the leading portion 14 is aligned with the leading portion 15, the sheet is bonded with the adhesive layer 13 and the input device 10 shown in FIG. 3B is formed. In other words, the input device 10 of the exemplary embodiment is formed with the insulating layer 11, the conductive layer 12 and the adhesive layer 13 by two layers each through the adhesive layer 13. Moreover, the number of the units configured by the insulating layer 11 and the conductive layer 12 is two, and the two units form the laminated body with the adhesive layer 13 interposed therebetween. This structure can be said that the laminated body is the units that are folded and overlapped. Note that, the adhesive layer 13 is provided close to the center part of the sheet in FIG. 3A and is not provided in the vicinity of the leading portions 14 and 15. Thereby, even in a case where the vicinity of the leading portions 14 and 15 is assumed to be the contacting surface, it is less likely to cause distortions at the part of contacting surface in the input device 10 of FIG. 3C.

In the input device 10 of the exemplary embodiment, as shown in FIG. 3D, the conductive layer 12 is the center portion in the thickness direction of the input device 10 and the insulating layer 11 is outside. Thereby, the amount of expansion and contraction of the conductive layer 12 is reduced, and it is possible to further suppress the occurrence of plastic deformation of the conductive layer 12.

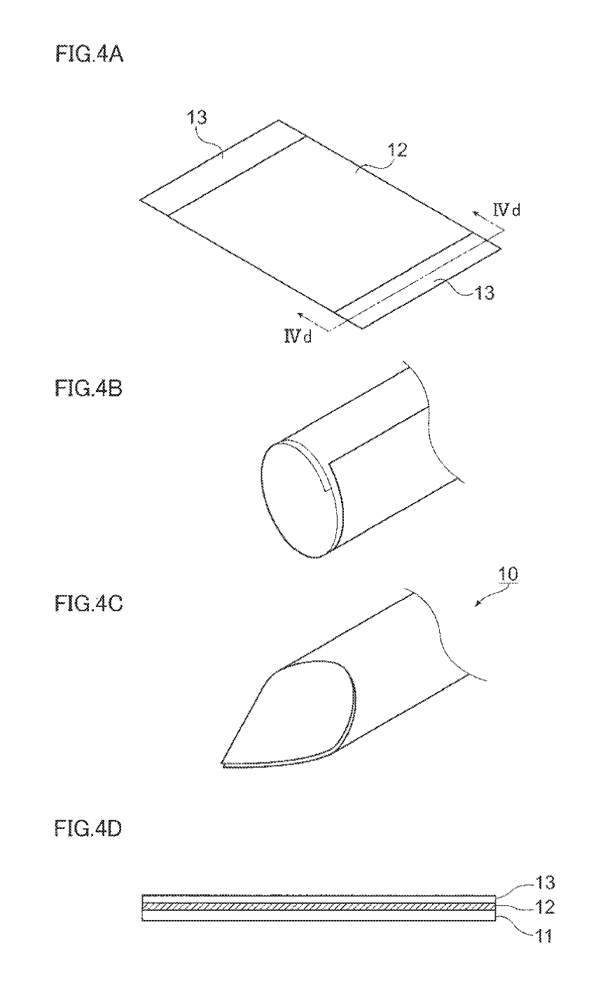

FIGS. 4A to 4D are diagrams for illustrating other example of the input device 10 to which the exemplary embodiment is applied.

Here, the input device 10 shown in FIG. 4C is the sheet shown in FIG. 4A winded several times, rolled in the form of a cylindrical shape, and cut so that the edge portion of one side forms a leading portion. Also the FIG. 4D is a IVd-IVd cross-sectional view of the sheet shown in FIG. 4A.

As shown in FIG. 4D, the sheet in FIG. 4A is configured by the structure in which the insulating layer 11, the conductive layer 12, and the adhesive layer 13 are laminated. By winding the sheet shown in FIG. 4A several times to form the cylindrical shape in FIG. 4B, the whole of the input device 10 in FIG. 4C is configured by the multiple sheets. In other words, the input device 10 of the exemplary embodiment is formed with the multiple insulating layers 11 and the multiple conductive layers 12, and is configured by the laminated body that is the multiple laminated units which are configured by the insulating body 11 and the conductive body 12. Note that, the adhesive layer 13 is provided close to the both of the edges in FIG. 4A and is not provided close to the center part. Thereby, in the case where the sheet in FIG. 4A is assumed to be the input device 10, it is possible to set the part where the adhesive layer 13 is provided not to be the contacting surface and it is less likely to cause distortions at the contacting surface.

### Description of Assembly of Input Device

An assembly, in which input devices 10 are gathered, will be described.

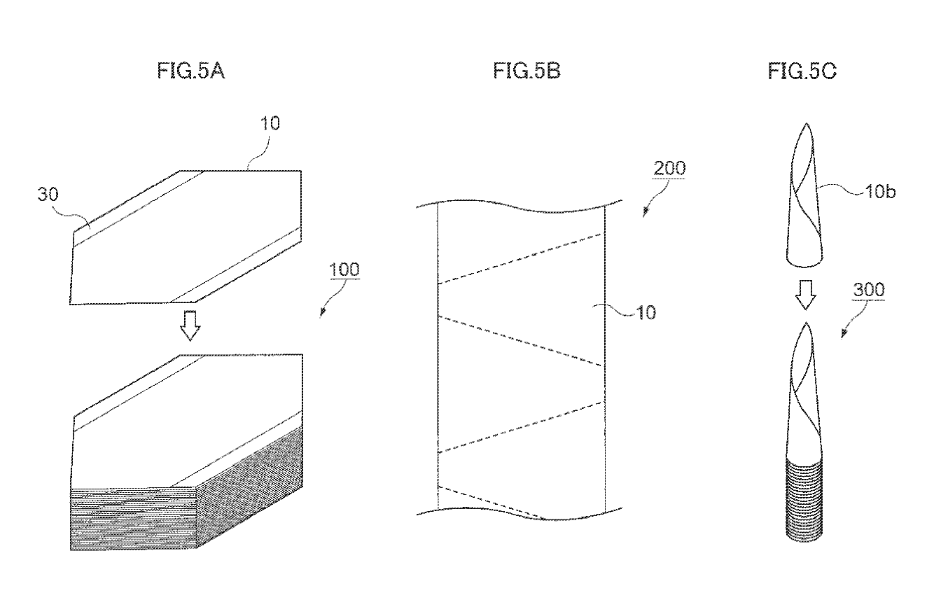

FIGS. 5A to 5C are diagrams for illustrating the first to third specific examples of the assembly of the input devices.

Here, FIG. 5A is a diagram for illustrating the first specific example of the assembly of the input devices 10.

An assembly 100 shown in FIG. 5A is the one in which the input devices 10 are laminated toward the thickness direction. The assembly 100 is provided by laminating the input devices 10 with the adhesive layer 13 interposed therebetween. By providing such an embodiment, in the case where the input device 10 is distributed, the input devices 10 can be distributed in group as the assembly 100. Accordingly, the users of input device 10 can use the input device 10 by taking the input device 10 from the assembly 100 one by one so that the input device 10 are worn on the writing material 20 or the finger 30 as the supporting body.

FIG. 5B is a diagram for illustrating the second specific example of the assembly of the input devices 10.

The assembly 200 shown in FIG. 5B is the one in which the input devices having trapezoidal shape are planately combined with each other. In this exemplary embodiment, the borders between the individual input devices 10 are perforated, thereby the individual input devices 10 are combined with each other. The users of the input device 10 can tear the part of the perforation of the assembly 200 to separate so that the input device 10 are worn on the writing material 20 and the finger 30 as the supporting body to use the input device 10.

In this exemplary embodiment, it is possible to form the assembly 200 into a tape shape by reversing a direction of the individual input devices 10 each other to combine. In the embodiment of rolling up the assembly having the tape shape, the assembly 200 can be distributed.

FIG. 5C is a diagram for illustrating the third specific example of the assembly of the input devices 10.

In the assembly 300 shown in FIG. 5C, the input devices 10b having cylindrical shape are laminated to form the assembly 300. By providing such an embodiment, the users of the input device 10b can use the input device 10b by taking the input device 10b from the assembly 300 one by one so that the input device 10b are worn on the writing material 20 or the finger 30 as the supporting body. In this embodiment, it is not necessary to wind the input device 10 to be worn on the writing material 20 or the finger 30 as the supporting body. Thereby, the users can use the input device 10b immediately.

By providing the assembly with the input devices 10 as above-described, the users can carry around the assembly to immediately have the alternative input device 10 although the input device 10 is lost. Therefore the users are much less likely to lose any means for inputting into the touch panel though the input device 10 is lost.

### REFERENCE SIGNS LIST

10 . . . Input device
11 . . . Insulating layer
12 . . . Conductive layer
13 . . . Adhesive layer
20 . . . Writing material
30 . . . Finger
100, 200, 300 . . . Assembly

1. An input device for inputting a position on a capacitive touch panel by making the input device contact with the touch panel, the input device comprising:
an insulating layer that has flexibility; and
a conductive layer that is laminated onto the insulating layer, wherein
a plurality of units are laminated to be a laminated body and form a cylindrical shape, the unit being configured by the insulating layer and the conductive layer.

2. The input device according to claim 1, further comprising an adhesive layer that is provided at least on a part of the unit.

3. The input device according to claim 1, wherein the laminated body is the units that are folded and overlapped.

4. The input device according to claim 1, wherein the thickness of the laminated body is in the range of 10 μm to 300 μm.

5. The input device according to claim 1, wherein the laminated body is the units that are winded several times.

6. An input device for inputting a position on a capacitive touch panel by making the input device contact with the touch panel, the input device comprising:
an insulating layer that has flexibility; and
a conductive layer that is laminated onto the insulating layer, wherein
a plurality of units are laminated to be a laminated body, and the laminated body can be bended to fit a shape of a supporting body, the unit being configured by the insulating layer and the conductive layer.

7. The input device according to claim 6, further comprising an adhesive layer that is provided at least on a part of the unit.

8. The input device according to claim 6, wherein the supporting body is a finger.

9. The input device according to claim 6, wherein the laminated body forms a shape of pentagon or hexagon.

10. An input method comprising:
making the input device according to claim 1 contact with the touch panel to input a position on a capacitive touch panel.

11. An assembly in which input devices for inputting a position on a capacitive touch panel by making the input device contact with the touch panel are gathered, wherein:
the input devices include a laminated body in which a plurality of units are laminated, the unit being configured by an insulating layer that has a flexibility and a conductive layer that is laminated onto the insulating layer; and
the input devices are gathered by any one of (1) to (3) below,
(1) further including an adhesive layer provided at least on a part of the unit and making the input devices laminated with the adhesive layer interposed therebetween,
(2) planately combining the input devices with each other, and
(3) forming the input device to be cylindrical shape and making the input devices of cylindrical shape laminated.
